(19) United States
(12) Patent Application Publication
(10) Pub. No.: US 2024/0123557 A1
(43) Pub. Date: Apr. 18, 2024

(54) Production process for PEAK racket

(71) Applicant: Hongping Xu, Nanchang (CN)

(72) Inventor: Hongping Xu, Nanchang (CN)

(21) Appl. No.: 18/389,199

(22) Filed: Nov. 13, 2023

(51) Int. Cl. B23P 13/00

(52) U.S. Cl. CPC B23P 13/00; A63B 60/002

(57) ABSTRACT

A process of manufacturing a PEAK racket includes the steps of taking a substrate layer, where the substrate layer is adapted to a PEAK racket; cutting a first filling space at a middle of the substrate layer, and filling a low-density material in the first filling space; cutting a second filling space at an upper side of the substrate layer, and filling a high-density material in the second filling space; respectively attaching and fastening a panel on each of two surfaces of the substrate layer, to obtain a semi-finished product; and drilling at a middle of the semi-finished product to form a plurality of through holes that are used for reducing wind resistance, wherein each through hole runs through outer side surfaces of the two panels. There is further provided the step of wrapping an edge of the racket, and mounting a handle.

### BACKGROUND OF THE INVENTION

### 1. Field of the Invention

The invention relates to PEAK rackets and more particularly to a production process for a PEAK racket.

### 2. Description of Related Art

A pickleball, a sport played with a racket, is on the rise from Bainbridge Island of Seattle in the Washington state of the United States. It is best described as a mixture of tennis, badminton, and table tennis. The pickleball was invented by two men. A name of “pickle” ball comes from a dog of one of the inventors. A dog, named Pickle, used to run with the ball in its mouth when the invention tries to bite the ball.

At present, substrate layers of most rackets on the market are made of a PP honeycomb material, and panels are attached and fastened to two surfaces of the substrate layer respectively. A substrate layer of a racket with this structure is made of a same material, that is, made of a PP material. As a result, elasticity of the racket is lacking, and the racket is heavy. Therefore, a user feels poor while using the racket, and is not durable. Hitting sound is large, and it is hard to hit a ball. This reduces experience of the user.

Thus, the need for improvement still exists.

### SUMMARY OF THE INVENTION

In view of this, to resolve problems existing in a conventional technology, a main purpose of the invention is to provide a production process for a PEAK racket. The production process for a PEAK racket can effectively resolve problems of the PEAK racket, for example, elasticity is poor, the racket is heavy and not durable, hitting sound is large, and it is hard to hit a ball.

To achieve the foregoing objective, the following technical solutions are used in the invention. A production process for a PEAK racket includes the steps of (a) taking a substrate layer, wherein the substrate layer is adapted to a PEAK racket; (b) cutting a first filling space at a middle of the substrate layer, and filling a low-density material in the first filling space; (c) cutting a second filling space at an upper side of the substrate layer, and filling a high-density material in the second filling space; (d) respectively attaching and fastening a panel on each of two surfaces of the substrate layer, to obtain a semi-finished product; and (e) drilling at a middle of the semi-finished product to form a plurality of through holes that are used for reducing wind resistance, wherein each through hole runs through outer side surfaces of the two panels.

Preferably, the substrate layer is made of a PP honeycomb material.

Preferably, the low-density material is foam cotton.

Preferably, the high-density material is a metal block or a non-metal block.

Preferably, the first filling space is square, and two side surfaces of the low-density material are flush with the two surfaces of the substrate layer respectively.

Preferably, the second filling space is rectangular, and two side surfaces of the high-density material are flush with the two surfaces of the substrate layer respectively.

Preferably, the panel is a glass fiber panel or a carbon fiber panel.

Preferably, the panel is attached and fastened to the surface of the substrate layer by a bonding layer.

Preferably, the semi-finished product in step (e) is molded and drilled by a CNC numerical control machine.

Preferably, the production process for a PEAK racket further includes the step (f) of wrapping an edge of the racket, and mounting a handle.

Compared with the conventional art, the invention has advantages and beneficial effects. Specifically, it may be learned from the foregoing technical solution: By filling of the low-density material is filled in the first filling space, elasticity is entranced, and a weight of the racket is reduced. Therefore, a user feels better while using the racket, and the racket is more durable. Because the low-density material has sound absorption effect, hitting sound is little. In addition, in a process of hitting a ball, because gravity of the racket is at upper side, a high-density material can be filled at an upper part, that is, in the second filling space. A user can easily hit the ball in a principle of inertia. This saves physical strength, reduces the hitting sound, and enhances enjoyment of playing the ball. The through hole is formed by drilling, so that wind resistance can be reduced by the through hole. This saves the physical strength of the user, and enhances enjoyment of playing the ball.

The above and other objects, features and advantages of the invention will become apparent from the following detailed description taken with the accompanying drawings.

### BRIEF DESCRIPTION OF THE DRAWINGS

FIG. 1 is a front view of a PEAK racket according to a preferred embodiment of the invention; and

FIG. 2 is a sectional view taken along line 2-2 of FIG. 1.

### DETAILED DESCRIPTION OF THE INVENTION

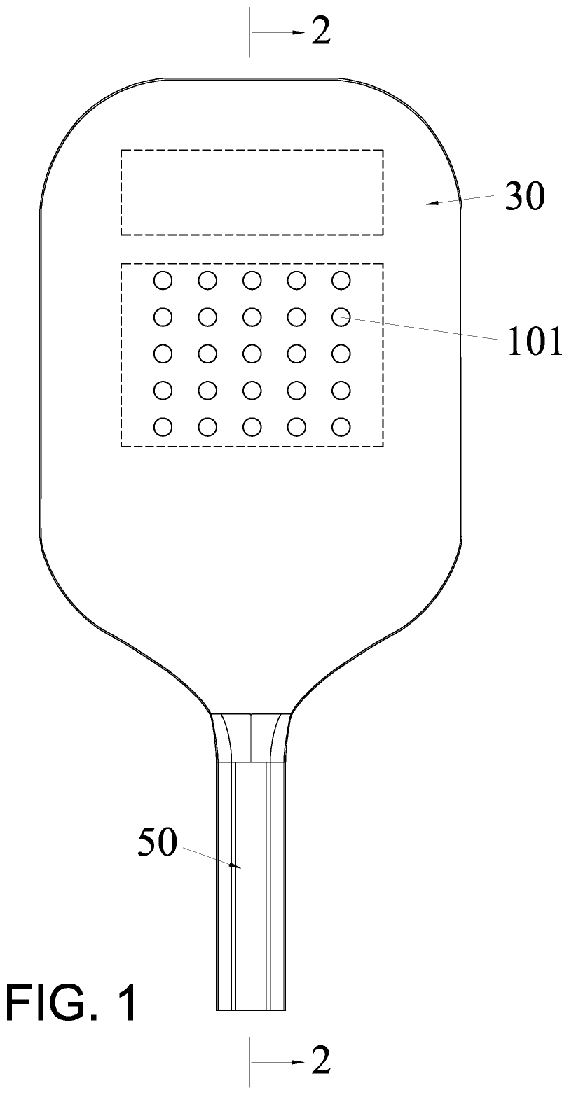

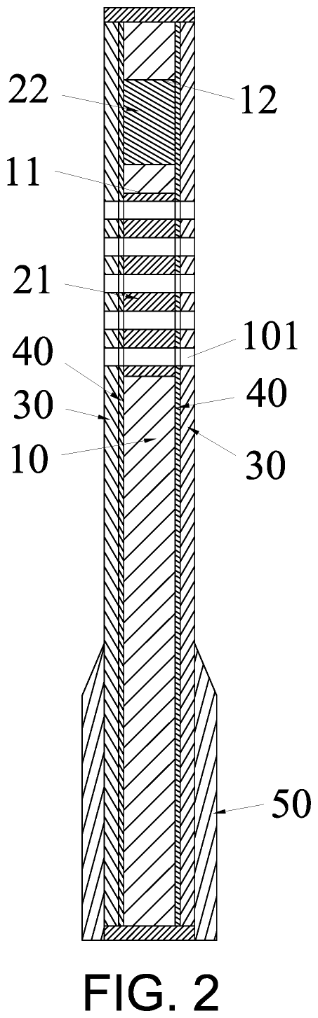

Referring to FIGS. 1 to 2, a production process for a PEAK racket of the invention is illustrated. The production process for a PEAK racket comprises the following steps: (a) Take a substrate layer 10, where the substrate layer 10 is adapted to a PEAK racket. The substrate layer 10 is made of a PP honeycomb material. (b) Cut a first filling space 11 at a middle of the substrate layer 10, and fill a low-density material 21 in the first filling space 11. Therefore, elasticity is entranced, and a weight of the racket is reduced. Therefore, a user feels better while using the racket, and the racket is more durable. Due to the low-density material 21, hitting sound is little. In this embodiment, the low-density material 21 is foam cotton, and this is not limited herein. Density of the low-density material 21 is less than that of the substrate layer 10. The first filling space 11 is square, and two side surfaces of the low-density material 21 are flush with the two surfaces of the substrate layer 10 respectively. (c) Cut a second filling space 12 at an upper side of the substrate layer 10, and filling a high-density material 22 in the second filling space 12. In a process of hitting a ball, because gravity of the racket is at upper side, the high-density material 22 can be filled at an upper part. Therefore, a user can easily hit the ball in a principle of inertia. This saves physical strength, and enhances enjoyment of playing the ball. In this embodiment, the high-density material 22 is a metal block or a non-metal block, and this is not limited herein. Density of the high-density material 22 is greater than that of the substrate layer 10. The second filling space 12 is rectangular, and two side surfaces of the high-density material 22 are flush with the two surfaces of the substrate layer 10 respectively. (d) Respectively attach and fasten a panel 30 on each of two surfaces of the substrate layer 10, to obtain a semi-finished product. In this embodiment, the panel 30 is a glass fiber panel or a carbon fiber panel, and this is not limited herein. The panel 30 is attached and fastened to the surface of the substrate layer 10 by a bonding layer 40. (e) Drill at a middle of the semi-finished product to form a plurality of through holes 101 that are used for reducing wind resistance, where each through hole 101 runs through outer side surfaces of the two panels 30. Due to the plurality of through holes 101, the physical strength of the user is saved, enjoyment of playing the ball is enhanced. In this embodiment, the semi-finished product is molded and drilled by a CNC numerical control machine. (f) Wrap an edge of the racket, and mount a handle 50.

Key points of design in the invention are: By filling of the low-density material is filled in the first filling space, elasticity is entranced, and a weight of the racket is reduced. Therefore, a user feels better while using the racket, and the racket is more durable. Because the low-density material has sound absorption effect, hitting sound is little. In addition, in a process of hitting a ball, because gravity of the racket is at upper side, a high-density material can be filled at an upper part, that is, in the second filling space. A user can easily hit the ball in a principle of inertia. This saves physical strength, reduces the hitting sound, and enhances enjoyment of playing the ball. The through hole is formed by drilling, so that wind resistance can be reduced by the through hole. This saves the physical strength of the user, and enhances enjoyment of playing the ball.

While the invention has been described in terms of preferred embodiments, those skilled in the art will recognize that the invention can be practiced with modifications within the spirit and scope of the appended claims.

What is claimed is:

1. A production process for a PEAK racket, comprising the steps of:
(a) taking a substrate layer, wherein the substrate layer is adapted to a PEAK racket;
(b) cutting a first filling space at a middle of the substrate layer, and filling a low-density material in the first filling space;
(c) cutting a second filling space at an upper side of the substrate layer, and filling a high-density material in the second filling space;
(d) respectively attaching and fastening a panel on each of two surfaces of the substrate layer, to obtain a semi-finished product; and
(e) drilling at a middle of the semi-finished product to form a plurality of through holes that are used for reducing wind resistance, wherein each through hole runs through outer side surfaces of the two panels.

2. The production process for a PEAK racket of claim 1, wherein the substrate layer is made of a PP honeycomb material.

3. The production process for a PEAK racket of claim 1, wherein the low-density material is foam cotton.

4. The production process for a PEAK racket of claim 1, wherein the high-density material is a metal block or a non-metal block.

5. The production process for a PEAK racket of claim 1, wherein the first filling space is square, and two side surfaces of the low-density material are flush with the two surfaces of the substrate layer respectively.

6. The production process for a PEAK racket of claim 1, wherein the second filling space is rectangular, and two side surfaces of the high-density material are flush with the two surfaces of the substrate layer respectively.

7. The production process for a PEAK racket of claim 1, wherein the panel is a fiber glass panel or a carbon fiber panel.

8. The production process for a PEAK racket of claim 1, wherein the panel is attached and fastened to the surface of the substrate layer by a bonding layer.

9. The production process for a PEAK racket of claim 1, wherein the semi-finished product in step (e) is molded and drilled by a CNC numerical control machine.

10. The production process for a PEAK racket of claim 1, further comprising the step of (f) wrapping an edge of the racket, and mounting a handle.
